(19) United States
(12) Patent Application Publication
(10) Pub. No.: US 2020/0202226 A1
(43) Pub. Date: Jun. 25, 2020

(54) SYSTEM AND METHOD FOR CONTEXT BASED DEEP KNOWLEDGE TRACING

(71) Applicant: FUJI XEROX CO., LTD., Tokyo (JP)

(72) Inventors: Koki NAGATANI, Kanagawa (JP); Francine Chen, Menlo Park, CA (US); Yin-Ying Chen, San Jose, CA (US)

(21) Appl. No.: 16/227,767

(22) Filed: Dec. 20, 2018

(51) Int. Cl. G06N 5/02; G06N 3/08; G06F 16/332; G09B 7/02

(52) U.S. Cl. CPC G06N 5/02; G09B 7/02; G06F 16/3329; G06N 3/08

(57) ABSTRACT

A method and system for training a user comprising detecting, by a neural network, a relationship pair comprising a question previously answered by the user and the score for the previously answered question, detecting context information associated with the question previously answered, the context information representing conditions occurring at the time the user previously answered the question, determining a probability that the user will successfully answer a subsequent question selected from potential questions based on the detected relationship pair and the detected context information associated with the question previously answered by the user; and selecting questions to be answered by the user based on the determined probability.

### BACKGROUND

### Field

The present disclosure relates to computer-aided education, and more specifically, to systems and methods for computer-aided education with contextual deep knowledge tracing.

### Related Art

In computer-aided education, a system provides students with personalized content based on their individual knowledge or abilities, which helps anchoring of their knowledge or reducing the learning cost. In some related art systems, a knowledge tracing task, which is modeling students' knowledge through their interactions with contents in the system, may be a challenging problem in the domain. In the related art systems, the more precise the modeling is, the more satisfactory and suitable contents the system can provide. Thus, in computer aided education, tracing each student's knowledge over time may be important to provide each with personalized learning content.

In some related art systems, a deep knowledge tracing (DKT) model may show that deep learning can model a student's knowledge more precisely. However, the related art approaches only consider the sequence of interactions between a user and questions, without taking into account other contextual information or integrating it into knowledge tracing. Thus, related art systems do not consider contextual knowledge, such as the time gaps between questions, exercise types, and the number of times the user interacts with the same question, for sequential questions presented by automated learning or training systems.

For example, related art knowledge tracing models such as Bayesian Knowledge Tracing and Performance Factor analysis have been explored widely and applied to the actual intelligent tutoring system. As deep learning models may beat other related art models in a range of domains such as pattern recognition and natural language processing, related art Deep Knowledge Tracing may show that deep learning can model a student's knowledge more precisely compared with these models. These related art DKT models students' knowledge by a recurrent neural network which often uses for sequential processing over time.

However, while the related art DKT may exhibit promising results, these systems only considers the sequence of interactions between a user and contents, without taking into account other essential contextual information and integrating it into knowledge tracing.

### SUMMARY OF THE DISCLOSURE

Aspects of the present application may relate to a method of tailoring training questions to a specific user in a computer based training system. The method may include detecting, by a neural network at least one relationship pair, each relationship pair comprising a question previously answered by the specific user and the specific user's previous score for at least one previously answered question, detecting, by the neural network, context information associated with the at least one question previously answered by the user, the context information representing conditions or circumstances occurring at the time of the user previously answered the at least one question, determining, by the neural network, a probability that the specific user will successfully answer a subsequent question selected from a plurality of potential questions based on the detected relationship pairs and the detected context information associated with the at least one question previously answered by the user, selecting questions to be answered by the user based on the determined probability in order to facilitate training of the user.

Additional aspects of the present application may relate to a non-transitory computer readable medium having stored therein a program for making a computer execute a method of tailoring training questions to a specific user in a computer based training system. The method may include detecting, by a neural network at least one relationship pair, each relationship pair comprising a question previously answered by the specific user and the specific user's previous score for at least one previously answered question, detecting, by the neural network, context information associated with the at least one question previously answered by the user, the context information representing conditions or circumstances occurring at the time of the user previously answered the at least one question, determining, by the neural network, a probability that the specific user will successfully answer a subsequent question selected from a plurality of potential questions based on the detected relationship pairs and the detected context information associated with the at least one question previously answered by the user, selecting questions to be answered by the user based on the determined probability in order to facilitate training of the user.

Further aspects of the present application relate to a computer based training system. The system may include a display, which displays questions to a user, a user input device, which received answers from the user, and a processor, which performs a method of tailoring questions to the user. The method may include detecting, by a neural network at least one relationship pair, each relationship pair comprising a question previously answered by the specific user and the specific user's previous score for at least one previously answered question, detecting, by the neural network, context information associated with the at least one question previously answered by the user, the context information representing conditions or circumstances occurring at the time of the user previously answered the at least one question, determining, by the neural network, a probability that the specific user will successfully answer a subsequent question selected from a plurality of potential questions based on the detected relationship pairs and the detected context information associated with the at least one question previously answered by the user, controlling the display to display questions to be answered by the user based on the determined probability in order to facilitate training of the user.

Still further aspects of the present application relate to a computer based training system. The system may include display means for displaying questions to a user, means for receiving answers from the user, means for detecting, by a neural network at least one relationship pair, each relationship pair comprising a question previously answered by the specific user and the specific user's previous score for at least one previously answered question, means for detecting, by the neural network, context information associated with the at least one question previously answered by the user, the context information representing conditions or circumstances occurring at the time of the user previously answered the at least one question, means for determining, by the neural network, a probability that the specific user will successfully answer a subsequent question selected from a plurality of potential questions based on the detected relationship pairs and the detected context information associated with the at least one question previously answered by the user, and means for selecting questions to be answered by the user based on the determined probability in order to facilitate training of the user.

Aspects of the present application may relate to a method of tailoring training questions to a specific user in a computer based training system. The method may include detecting, by a neural network, at least one relationship pair, each relationship pair comprising a question previously answered by the specific user and the specific user's previous score for at least one previously answered question, detecting, by the neural network, context information associated with at least one potential question to be presented to the specific user, the context information representing conditions or circumstances occurring at the time of the at least one question is to be presented to the specific user, determining, by the neural network, a probability that the specific user will successfully answer the at least one potential question based on the detected at least one relationship pair and the detected context information associated with at least one potential question to be presented to the specific user, and selecting questions to be answered by the user based on the determined probability in order to facilitate training of the user.

Additional aspects of the present application may relate to a non-transitory computer readable medium having stored therein a program for making a computer execute a method of tailoring training questions to a specific user in a computer based training system. The method may include detecting, by a neural network, at least one relationship pair, each relationship pair comprising a question previously answered by the specific user and the specific user's previous score for at least one previously answered question, detecting, by the neural network, context information associated with at least one potential question to be presented to the specific user, the context information representing conditions or circumstances occurring at the time of the at least one question is to be presented to the specific user, determining, by the neural network, a probability that the specific user will successfully answer the at least one potential question based on the detected at least one relationship pair and the detected context information associated with at least one potential question to be presented to the specific user, and selecting questions to be answered by the user based on the determined probability in order to facilitate training of the user.

Further aspects of the present application relate to a computer based training system. The system may include a display, which displays questions to a user, a user input device, which received answers from the user, and a processor, which performs a method of tailoring questions to the user. The method may include detecting, by a neural network, at least one relationship pair, each relationship pair comprising a question previously answered by the specific user and the specific user's previous score for at least one previously answered question, detecting, by the neural network, context information associated with at least one potential question to be presented to the specific user, the context information representing conditions or circumstances occurring at the time of the at least one question is to be presented to the specific user, determining, by the neural network, a probability that the specific user will successfully answer the at least one potential question based on the detected at least one relationship pair and the detected context information associated with at least one potential question to be presented to the specific user, and controlling the display to display questions to be answered by the user based on the determined probability in order to facilitate training of the user.

Still further aspects of the present application relate to a computer based training system. The system may include display means for displaying questions to a user, means for receiving answers from the user, means for detecting, by a neural network, at least one relationship pair, each relationship pair comprising a question previously answered by the specific user and the specific user's previous score for at least one previously answered question, means for detecting, by the neural network, context information associated with at least one potential question to be presented to the specific user, the context information representing conditions or circumstances occurring at the time of the at least one question is to be presented to the specific user, means for determining, by the neural network, a probability that the specific user will successfully answer the at least one potential question based on the detected at least one relationship pair and the detected context information associated with at least one potential question to be presented to the specific user, and means for selecting questions to be answered by the user based on the determined probability in order to facilitate training of the user.

Aspects of the present application may relate to a method of tailoring training questions to a specific user in a computer based training system. The method may include detecting, by a neural network, at least one relationship pair, each relationship pair comprising a question previously answered by the specific user and the specific user's previous score for at least one previously answered question, detecting, by the neural network, context information associated with at least one potential question to be presented to the specific user, the context information representing conditions or circumstances occurring at the time of the at least one question is to be presented to the specific user, determining, by the neural network, a probability that the specific user will successfully answer the at least one potential question based on the detected at least one relationship pair and the detected context information associated with at least one potential question to be presented to the specific user, and selecting questions to be answered by the user based on the determined probability in order to facilitate training of the user.

Additional aspects of the present application may relate to a non-transitory computer readable medium having stored therein a program for making a computer execute a method of tailoring training questions to a specific user in a computer based training system. The method may include detecting, by a neural network, at least one relationship pair, each relationship pair comprising a question previously answered by the specific user and the specific user's previous score for at least one previously answered question, detecting, by the neural network, context information associated with at least one potential question to be presented to the specific user, the context information representing conditions or circumstances occurring at the time of the at least one question is to be presented to the specific user, determining, by the neural network, a probability that the specific user will successfully answer the at least one potential question based on the detected at least one relationship pair and the detected context information associated with at least one potential question to be presented to the specific user, and selecting questions to be answered by the user based on the determined probability in order to facilitate training of the user.

Further aspects of the present application relate to a computer based training system. The system may include a display, which displays questions to a user, a user input device, which received answers from the user, and a processor, which performs a method of tailoring questions to the user. The method may include detecting, by a neural network, at least one relationship pair, each relationship pair comprising a question previously answered by the specific user and the specific user's previous score for at least one previously answered question, detecting, by the neural network, context information associated with at least one potential question to be presented to the specific user, the context information representing conditions or circumstances occurring at the time of the at least one question is to be presented to the specific user, determining, by the neural network, a probability that the specific user will successfully answer the at least one potential question based on the detected at least one relationship pair and the detected context information associated with at least one potential question to be presented to the specific user, and controlling the display to display questions to be answered by the user based on the determined probability in order to facilitate training of the user.

Still further aspects of the present application relate to a computer based training system. The system may include display means for displaying questions to a user, means for receiving answers from the user, means for detecting, by a neural network, at least one relationship pair, each relationship pair comprising a question previously answered by the specific user and the specific user's previous score for at least one previously answered question, means for detecting, by the neural network, context information associated with at least one potential question to be presented to the specific user, the context information representing conditions or circumstances occurring at the time of the at least one question is to be presented to the specific user, means for determining, by the neural network, a probability that the specific user will successfully answer the at least one potential question based on the detected at least one relationship pair and the detected context information associated with at least one potential question to be presented to the specific user, and means for selecting questions to be answered by the user based on the determined probability in order to facilitate training of the user.

Aspects of the present application may relate to a method of tailoring training questions to a specific user in a computer based training system. The method may include detecting, by a neural network at least one relationship pair, each relationship pair comprising a question previously answered by the specific user and the specific user's previous score for at least one previously answered question; detecting, by the neural network, context information associated with the at least one question previously answered by the user, the context information representing conditions or circumstances occurring at the time of the user previously answered the at least one question; detecting, by the neural network, context information associated with the at least one potential question to be presented to the specific user, the context information representing conditions or circumstances occurring at the time of the at least one question is to be presented to the specific user; determining, by the neural network, a probability that the specific user will successfully answer the at least one potential question successfully based on the detected relationship pairs, the detected context information associated with the at least one question previously answered by the user, and the detected context information associated with the at least one potential question to be presented to the specific user; and selecting questions to be answered by the user based on the determined probability in order to facilitate training of the user.

Additional aspects of the present application may relate to a non-transitory computer readable medium having stored therein a program for making a computer execute a method of tailoring training questions to a specific user in a computer based training system. The method may include detecting, by a neural network at least one relationship pair, each relationship pair comprising a question previously answered by the specific user and the specific user's previous score for at least one previously answered question; detecting, by the neural network, context information associated with the at least one question previously answered by the user, the context information representing conditions or circumstances occurring at the time of the user previously answered the at least one question; detecting, by the neural network, context information associated with the at least one potential question to be presented to the specific user, the context information representing conditions or circumstances occurring at the time of the at least one question is to be presented to the specific user; determining, by the neural network, a probability that the specific user will successfully answer the at least one potential question successfully based on the detected relationship pairs, the detected context information associated with the at least one question previously answered by the user, and the detected context information associated with the at least one potential question to be presented to the specific user; and selecting questions to be answered by the user based on the determined probability in order to facilitate training of the user.

Further aspects of the present application relate to a computer based training system. The system may include a display, which displays questions to a user, a user input device, which received answers from the user, and a processor, which performs a method of tailoring questions to the user. The method may include detecting, by a neural network at least one relationship pair, each relationship pair comprising a question previously answered by the specific user and the specific user's previous score for at least one previously answered question; detecting, by the neural network, context information associated with the at least one question previously answered by the user, the context information representing conditions or circumstances occurring at the time of the user previously answered the at least one question; detecting, by the neural network, context information associated with the at least one potential question to be presented to the specific user, the context information representing conditions or circumstances occurring at the time of the at least one question is to be presented to the specific user; determining, by the neural network, a probability that the specific user will successfully answer the at least one potential question successfully based on the detected relationship pairs, the detected context information associated with the at least one question previously answered by the user, and the detected context information associated with the at least one potential question to be presented to the specific user; and controlling the display to display questions to be answered by the user based on the determined probability in order to facilitate training of the user.

Still further aspects of the present application relate to a computer based training system. The system may include display means for displaying questions to a user, means for receiving answers from the user, means for detecting, by a neural network at least one relationship pair, each relationship pair comprising a question previously answered by the specific user and the specific user's previous score for at least one previously answered question; means for detecting, by the neural network, context information associated with the at least one question previously answered by the user, the context information representing conditions or circumstances occurring at the time of the user previously answered the at least one question; means for detecting, by the neural network, context information associated with the at least one potential question to be presented to the specific user, the context information representing conditions or circumstances occurring at the time of the at least one question is to be presented to the specific user; means for determining, by the neural network, a probability that the specific user will successfully answer the at least one potential question successfully based on the detected relationship pairs, the detected context information associated with the at least one question previously answered by the user, and the detected context information associated with the at least one potential question to be presented to the specific user; and means for selecting questions to be answered by the user based on the determined probability in order to facilitate training of the user.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a flow chart of a process for performing deep learning tracing with contextual information being taken into consideration in accordance with example implementations of the present application.

FIG. 2 illustrates a flow chart of a process for comparative example of performing deep learning tracing without contextual information being taken into consideration.

FIG. 3 illustrates a schematic representation of a comparative processing model performing the process of FIG. 2 discussed above.

FIG. 4 illustrates a schematic representation of a processing model of a neural network performing process of FIG. 1 discussed above in accordance with an example implementation of the present application.

FIG. 5 illustrates a data flow diagram of a comparative processing model while performing the process of FIG. 2 discussed above.

FIG. 6 illustrates a data flow diagram of a processing model while performing the process of FIG. 1 in accordance with an example implementation of the present application.

FIG. 7 illustrates an example computing environment with an example computer device suitable for use in some example implementations of the present application.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

In the present application, the terms computer readable medium may include a local storage device, a cloud-based storage device, a remotely located server, or any other storage device that may be apparent to a person of ordinary skill in the art.

As described above in some related art computer-aided education systems may use a deep knowledge tracing (DKT) models to model a student's knowledge more precisely. However, the related art approaches only consider the sequence of interactions between a user and questions, without taking into account other contextual information or integrating the contextual information into knowledge tracing. Thus, related art systems do not consider contextual knowledge such as the time gaps between questions, exercise types, and the number of times the user interacts with the same question.

The present application describes a deep-learning tracing model that incorporates DKT model so that it considers contextual information. Such contextual information includes the time gap between questions, exercise types, and the number of times the user interacts with the same question. For example, students usually forget learned content as time passes. Without considering the time gap between questions, contents and questions with an inappropriate level of difficulty for students will be provided, which leads to a decrease in their engagement. Hence, contextual information which has a relation to the change of students' knowledge should be incorporated into model. Incorporating such contexts can trace students' knowledge more precisely, and realize contents provision more flexibly and more interpretably.

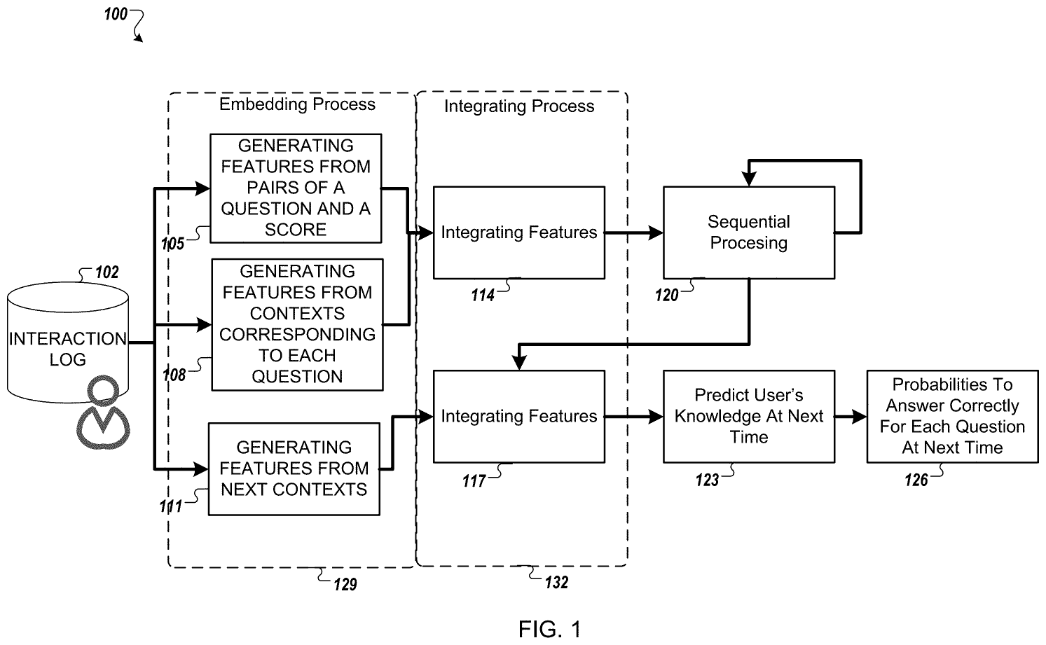

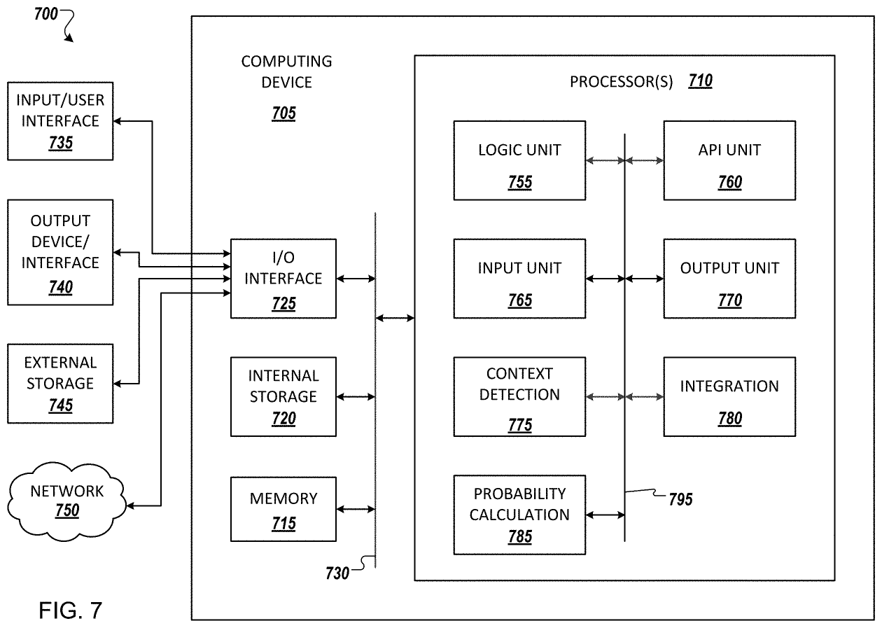

FIG. 1 illustrates a flow chart of a process 100 for performing deep learning tracing with contextual information being taken into consideration. The process 100 may be performed by a computing device in a computing environment such as example computing device 705 of the example computing environment 700 illustrated in FIG. 7 discussed below. Though the elements of process 100 may be illustrated in a particular sequence, example implementations are not limited to the particular sequence illustrated. Example implementations may include actions being ordered into a different sequence as may be apparent to a person of ordinary skill in the art or actions may be performed in parallel or dynamically, without departing from the scope of the present application.

As illustrated in FIG. 1, an interaction log 102 of a user's interaction with a computer based education or training system is generated and maintained. With the user's consent, a variety of aspects of the user's interaction with the education or training system may be monitored. For example, the interaction log 102 may include information on one or more of: which questions the user has gotten right or wrong, the number of questions the user has gotten right or wrong, the percentage of questions the user has gotten right or wrong, the types of questions the user has gotten right or wrong, the difficulty of questions the user has gotten right or wrong, the time a user has taken to answer each question, the time a user has taken between using the education or training system, the time of day, year, or month that the user is answering the question or any other interaction information that might be apparent to a person of ordinary skill in the art. Further, the interaction log 102 may also include information about the user including one or more of: name, address, age, educational background, or any other information that might be apparent to a person of ordinary skill in the art.

Additionally in some example implementations, the interaction log 102 may also include interaction information associated with users other than the specific user currently being tested. For example, the interaction log 102 may include percentages of users that have gotten a question right or wrong, time taken to answer the question by other users, and/or information about other uses including one or more of: name, address, age, educational background, or any other information that might be apparent to a person of ordinary skill in the art.

The process 100 includes an embedding process phase 129 and an integrating process phase 132. During the embedding process phase 129, features are generated based on corresponding pairs of questions and respective scores at 105. For example, one or more features may be generated based on each pair of a question and a score indicative whether the user answered the question correctly.

Further, during the embedding process features are generated corresponding to the context associated with each question answered by the user at 108. For example, features representative of the context may include the time elapsed between the question being presented and an answer being received from the user, whether the user has viewed or seen the question before, how the user has previously answered the question when previously presented, whether the question relates to a topic previously encountered by the user, or any other contextual information that might be apparent to a person of ordinary skill in the art, may be generated. Thus contextual information may be represented as multi-hot vector, in which the value of each type of contextual information is represented by one-hot vector or numerical value and then concatenated together. The contextual information vector may be transformed into different shapes depending on the method of integration discussed below. Additional contextual information types considered may be described in the evaluation section below.

Additionally, during the embedding process phase 129 features may also be generated corresponding to currently existing context of a question next to be presented to the user existing context associated with a question being presented at 111. For example, these context features may include a current time elapsed since the user was presented with a question, a time elapsed since the user encountered the same topic, whether the user has encountered the same question, a time elapsed since the user previously encountered the same question currently presented, a current time of day, week, month or year, or any other context information that might be apparent to a person of ordinary skill in the art. Again, this Contextual information may be represented as multi-hot vector, in which the value of each type of contextual information is represented by one-hot vector or numerical value and then concatenated together. The contextual information vector may be transformed into different shapes depending on the method of integration discussed below. Additional contextual information types considered may be described in the evaluation section below.

In the embedding process phase 129 of FIG. 1, the feature generating sub-processes of 105, 108 and 111 have been illustrated in parallel, but are not limited to this configuration. In some example implementations one or more of the feature generating sub-processes of 105, 108 and 11 may be performed sequentially.

During the integrating process phase 132 in FIG. 1, two feature integrating sub-processes 114 and 117 are provided. At 114, the contextual features generated associated with each previous question from 108 is integrated with the generated features associated with the pairs of each previously encountered question and score from 105. The contextual feature integration of 114 may be repeated for each question the user is presented and answers, each repetition being sequentially processed at 120to iteratively affect the a latent knowledge representation model to be used to predict future user performance. In doing so, the contextual information is incorporated into the model being generated and may affect a latent knowledge representation of the model. Several, context integration methods may be used in example implementations, including:

concatenation:

[xₜ; cₜ] (Formula 1)

multiplication:

xₜ⊙Ccₜ (Formula 2)

concatenation and multiplication:

[xₜ⊙Cc_{b}; Cr] (Formula 3)

bi-interaction::

ΣᵢΣⱼzⱼ⊙zⱼ, zᵢ ∈ {xt, Cicᵢ^{t}cᵢ^{t}≠0} (Formula 4)

where Xₜ is interaction vector, Cₜ is contextual information vector, C is learned transformation matrix, and “⊙” denotes element-wise multiplication. Concatenation may stack an interaction vector with a context information vector. Hence, this integration may not alter the interaction vector itself. On the other hand, multiplication may modify an interaction vector by the contextual information. Further, Bi-interaction encodes the second-order interactions between interaction vector and context information vector, and between context information vectors. Other integration methods may be used including, for example, pooling or any other integration method that might be apparent to a person of ordinary skill in the art.

At 117, the features corresponding to currently existing context of a question being presented or soon to be existing context associated with a question to be presented that was generated at 111, is integrated with the sequentially processed output from the integration at 114. Thus, the latent knowledge representation model from 120 may be integrated with a representation of the current context of that the user may be answer questions in. Again, one of the several, context integration methods described above with respect to 114 may be used in example implementations. In some example implementations, the same integration method may be used in both sub-processes 114 and 117. In other example implementations a different integration method may be used for each of sub-process 114 and sub-process 117.

After the integrating sub-process of 117, the resulting latent knowledge representation model with context feature consideration may be used to predict a user's knowledge prior to presenting a question at 123. Further, at 126 a probability that the user will answer a next question correctly may be determined. Based on the probability that a next question will be answered correctly, an education or training system may select a question designed to better challenge a user without presenting a challenge so great that a user would be discouraged from continuing. Thus, the education or training system may be automatically adjusted to provide an optimal challenge and training. For example, in some example implementations, the education or training system may automatically select questions having probabilities of being answered successfully above a first threshold (e.g., 50%) to encourage the student by ensuring a reasonable likelihood of success. Further, the education or training system may automatically select questions having probabilities below a second threshold (e.g., 95%) to ensure that the testing is not too easy in order to maintain interest or challenge to the user. In other example implementations, the education or training system may vary thresholds (e.g., randomly, based on a present pattern, or dynamically determined) to vary the difficulty of the questions in order to maintain interest from the student.

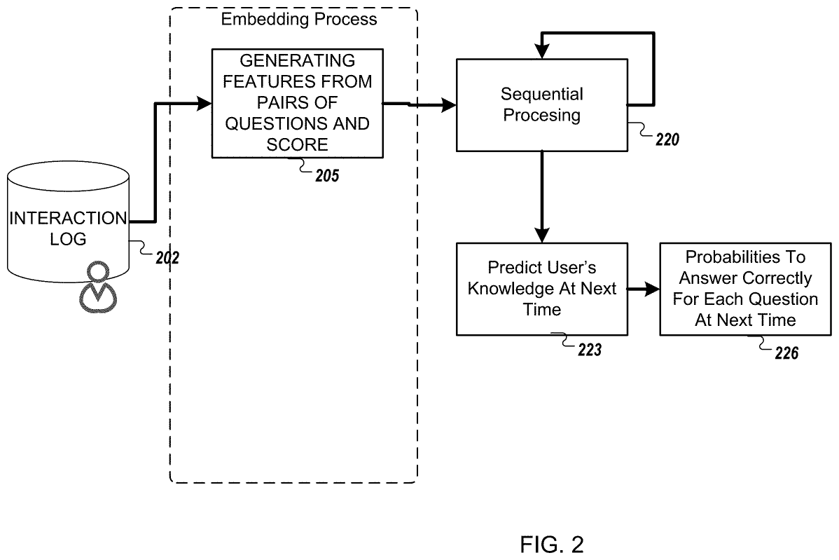

FIG. 2 illustrates a flow chart of a process 200 for comparative example of performing deep learning tracing without contextual information being taken into consideration. The process 200 may be performed by a computing device in a computing environment such as example computing device 705 of the example computing environment 700 illustrated in FIG. 7 discussed below.

As illustrated in FIG. 2, an interaction log 202 of a user's interaction with a computer based education or training system is generated and maintained. With the user's consent, a variety of aspects of the user's interaction with the education or training system may be monitored. For example, the interaction log 202 may include information on one or more of: which questions the user has gotten right or wrong, the number of questions, the user has gotten right or wrong, the percentage of questions the user has gotten right or wrong, the types of questions the user has gotten right or wrong, the difficulty of questions the user has gotten right or wrong, the time a user has taken to answer each question, the time a user has taken between using the education or training system, the time of day, year, or month that the user is answering the question or any other interaction information that might be apparent to a person of ordinary skill in the art. Further, the interaction log 202 may also include information about the user including one or more of: name, address, age, educational background, or any other information that might be apparent to a person of ordinary skill in the art.

Additionally in some example implementations, the interaction log 202 may also include interaction information associated with users other than the specific user currently being tested. For example, the interaction log 202 may include percentages of users that have gotten a question right or wrong, time taken to answer the question by other users, and/or information about other uses including one or more of: name, address, age, educational background, or any other information that might be apparent to a person of ordinary skill in the art.

During the process 200, features are generated based on corresponding pairs of questions and respective scores at 205. For example, one or more features may be generated based on each pair of a question and a score indicative whether the user answered the question correctly. The feature generation of 205 may be repeated for each question the user is presented and answered, each repetition being sequentially processed at 220 to iteratively affect a latent knowledge representation model to be used to predict future user performance.

After the sequential processing of 220, the resulting latent knowledge representation model with context feature consideration may be used to predict a user's knowledge prior to presenting a question at 223. Further, at 226 a probability that the user will answer a next question correctly may be determined. Based on the probability that a next question will be answered correctly, an education or training system may select a question design to better challenge a user without presenting a challenge so great that a user would be discouraged from continuing. However, in the comparative example process 200 of FIG. 2, latent knowledge representation model does not include sub-processes generating features based on context surrounding questions previously answered or features based on current context or questions being asked. Further, in comparative example process 200 no integration processes are performed to integrate features associated with contextual information into the latent knowledge representation model. Thus, no contextual information is considered in selecting which questions should be asked.

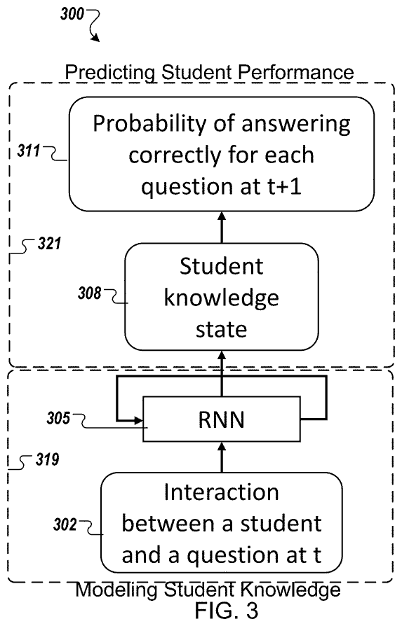

FIG. 3 illustrates a schematic representation of a comparative processing model 300 performing the process 200 discussed above. As illustrated by FIG. 3, a simple RNN-based modelling neural network 305may capture each student's knowledge sequentially at successive questions. For each question t, the model 300 may first model the student's knowledge at 319 and predict student performance 321 on a successive question t+1. In order to model the state of student knowledge 319, the modelling neural network 305 receives a pair of a questions and respective scores (qt, at) for time t and outputs a representation of the student's current knowledge state 308 at time t. Based on the output representation of the student's current knowledge state 308 at time t, the processing model 300 may determine a probability 311 of answering correctly for each question at t+1.

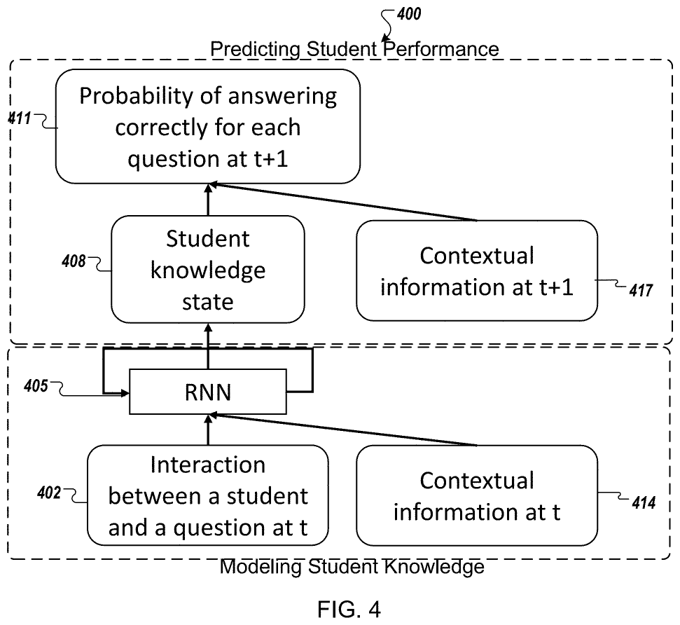

FIG. 4 illustrates a schematic representation of a processing model 400 of a neural network performing process 100 discussed above in accordance with an example implementation of the present application. As illustrated by FIG. 4, a simple RNN-based model 405 may capture each student's knowledge sequentially at successive questions. Again, for each question t, the model 400 may first model the student's knowledge at 419 and predict student performance 421 on a successive question t+1. However unlike the processing model 430, in processing model 400, the modeling neural network 405 receives both the pair of a questions and respective scores (qt, at) for time t 402 and contextual information associated with time t 414. As described above, the contextual information at time t may include the time elapsed between the question being presented and an answer being received from the user, whether the user has viewed or seen the question before, how the user has previously answered the question when previously presented, whether the question relates to a topic previously encountered by the user, or any other contextual information that might be apparent to a person of ordinary skill in the art, may be generated. Thus contextual information may be represented as multi-hot vector, in which the value of each type of contextual information is represented by one-hot vector or numerical value and then concatenated together. The contextual information vector may be transformed into different shapes depending on the method of integration discussed below. Additional contextual information types considered may be described in the evaluation section below.

In order to model the state of student knowledge 419, the modeling neural network 405 sequentially integrates the contextual information from time t with both the pair of questions and respective scores (qt, at) for time t 402 with the pair and outputs a representation of the student's current knowledge state 408 at time t. As described above, several, context integration methods may be used in example implementations, including:

concatenation:

[xₜ; cₜ] (Formula 1)

multiplication:

xₜ⊙Ccₜ (Formula 2)

concatenation and multiplication:

[xₜ⊙Ccₜ; Cr] (Formula 3)

bi-interaction::

ΣᵢΣⱼzᵢ⊙zⱼ, zⱼ ∈ {xt, Cicᵢ^{t}cᵢ^{t}≠0} (Formula 4)

where Xₜ is interaction vector, Cₜ is contextual information vector, C is learned transformation matrix, and “⊙” denotes element-wise multiplication. Concatenation may stack an interaction vector with a context information vector. Hence, this integration may not alter the interaction vector itself. On the other hand, multiplication may modify an interaction vector by the contextual information. Further, bi-interaction encodes the second-order interactions between interaction vector and context information vector, and between context information vectors. Other integration methods may be used including, for example, pooling or any other integration method that might be apparent to a person of ordinary skill in the art.

Based on the output representation of the student's current knowledge state 408 at time t, the processing model 400 may determine a probability 411 of answering correctly for each question at t+1. However, unlike comparative processing model 300, processing model 400may determine a probability 411 based not only one the current state student's current knowledge state 408 at time t, but also received contextual information associated with a subsequent time t+1 (e.g., a time of a subsequent question to be presented to a user). As discussed above the contextual information at time t+1 may be a current time elapsed since the user was presented with a question awaiting an answer, a time elapsed since the user encountered the same topic or same question currently presented, a current time of day, week, month or year, or any other context information that might be apparent to a person of ordinary skill in the art. Again, this Contextual information may be represented as multi-hot vector, in which the value of each type of contextual information is represented by one-hot vector or numerical value and then concatenated together. The contextual information vector may be transformed into different shapes depending on the method of integration discussed below. Additional contextual information types considered may be described in the evaluation section below.

Specifically, the comparative processing model 300 may integrate the current knowledge state of the student 408 with the contextual information at t+1 to determine a probability that the user will correctly answer the question at time t+1. For example, as described above, several, context integration methods may be used in example implementations, including:

concatenation:

[xₜ; cₜ] (Formula 1)

multiplication:

xₜ⊙Ccₜ (Formula 2)

concatenation and multiplication:

[xₜ⊙Ccₜ; Cr] (Formula 3)

bi-interaction::

ΣᵢΣⱼzᵢ⊙zⱼ, zᵢ ∈ {xt, Cicᵢ^{t}cᵢ^{t}≠0} (Formula 4)

where Xₜ is interaction vector, Cₜ is contextual information vector, C is learned transformation matrix, and “⊙” denotes element-wise multiplication. Concatenation may stack an interaction vector with a context information vector. Hence, this integration may not alter the interaction vector itself. On the other hand, multiplication may modify an interaction vector by the contextual information. Further, bi-interaction encodes the second-order interactions between interaction vector and context information vector, and between context information vectors. Other integration methods may be used including, for example, pooling or any other integration method that might be apparent to a person of ordinary skill in the art.

In some example implementations, the same integration methods may be used to integrate both the contextual information at time t 414 and the contextual information at subsequent time t+1 417. In other example implementations, the different integration methods may be used to integrate each of the contextual information at time t+1 and the contextual information at subsequent time t+1 417.

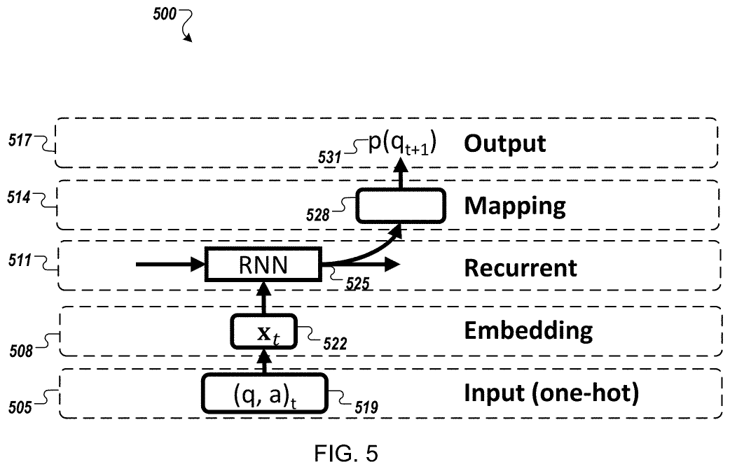

FIG. 5 illustrates a data flow diagram of a comparative processing model 500 while performing the process 200 discussed above. As illustrated, the comparative processing model 500 includes 5 layers of processing (505, 508, 511, 514, 517). As illustrated at the input layer 505, a question and score 519 associated with the student's answer to the question (qt, at) for time t are received as the input. At the embedding layer 508, the question and score pair 519 is embedded in an embedding vector xₜ 522 representation of the user/student's knowledge at time t with no recognition of the User's previous performance.

At the recurrent layer, 511, a recurrent neural network 525 receives the embedding vector xₜ and sequentially incorporates the embedding into model of the user's total knowledge at time t. Depending on the user's history of usage of an educational system, the recurrent layer may include sequentially incorporate successive question/score pairs into a preexisting vector representation of the user's knowledge if the User has previously answered question, or a newly created vector representation if the user has never previously answered a question.

At the mapping layer, 514, the vector representation 528 of the user's knowledge may be mapped to a question newly being presented or being considered for presentation to the user and a probability 531 that the user will answer the subsequent question is output at 517.

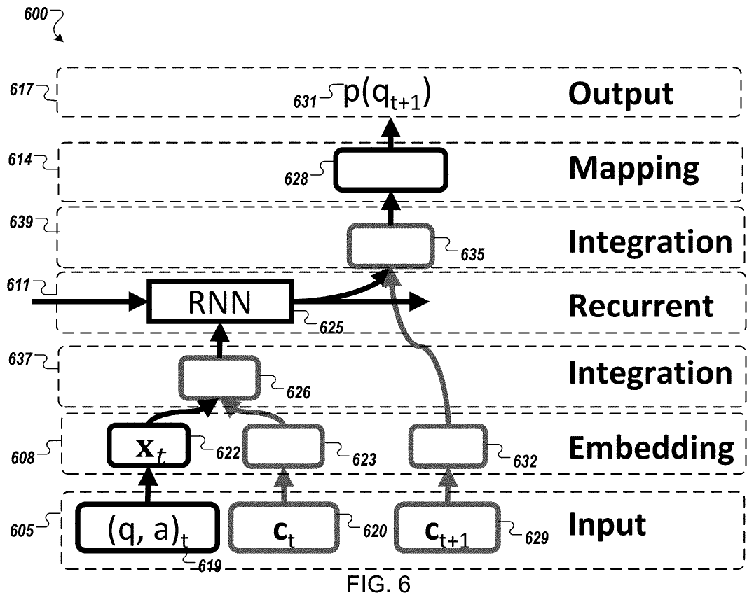

FIG. 6 illustrates a data flow diagram of a processing model 600 while performing the process 100 in accordance with an example implementation of the present application. As illustrated, the processing model 600 includes 7 layers of processing (605, 608, 611, 614, 617, 637. 639). As illustrated at the input layer 605, a question and score 619 associated with the student's answer to the question (qt, at) for time t are received as an input.

Additionally, during the input layer 605, context information cₜ 620 associated with the question and answer pair is also received. As described above, context information cₜ 620 may include the time elapsed between the question being presented and an answer being received from the user, whether the user has viewed or seen the question before, how the user has previously answered the question when previously presented, whether the question relates to a topic previously encountered by the user, or any other contextual information that might be apparent to a person of ordinary skill in the art, may be generated.

Further, during the input layer 605, context information cₜ₊₁ 629 associated with a next question to be answered is also received. As described above, these context features may include a current time elapsed since the user was presented with a question awaiting an answer, a time elapsed since the user encountered the same topic or same question currently presented, a current time of day, week, month or year, or any other context information that might be apparent to a person of ordinary skill in the art.

At the embedding layer 608, the question and score pair 619 is embedded in an embedding vector xₜ 622 representation of the user/student's knowledge at time t with no recognition of the User's previous performance.

Additionally, during the embedding layer 608, context information cₜ 620 associated with the question and answer pair is also embedded in a separate embedding vector 623. Thus, context information cₜ 620 may be represented as multi-hot vector, in which the value of each type of contextual information is represented by one-hot vector or numerical value and then concatenated together. The contextual information vector may be transformed into different shapes depending on the method of integration discussed below. Additional contextual information types considered may be described in the evaluation section below.

Further, during the embedding layer 608, context information cₜ₊₁ 629 associated with a next question to be answered is also embedded in a separate embedding vector 629. Again, this context information cₜ₊₁ 629 associated with a next question to be answered may be represented as multi-hot vector, in which the value of each type of contextual information is represented by one-hot vector or numerical value and then concatenated together. The contextual information vector may be transformed into different shapes depending on the method of integration discussed below. Additional contextual information types considered may be described in the evaluation section below.

After the embedding layer 608, a first integration layer 637 is provided to integrate the embedding vector xₜ 622 representation of the user/student's knowledge at time t with the embedding vector 623 based on the context information cₜ 620 associated with the question and answer pair to produce the integrated vector 626. Several, context integration methods may be used in example implementations, including:

concatenation:

[xₜ; cₜ] (Formula 1)

multiplication:

xₜ⊙Ccₜ (Formula 2)

concatenation and multiplication:

[xₜ⊙Ccₜ; Cr] (Formula 3)

bi-interaction::

ΣᵢΣⱼzᵢ⊙zⱼ, zᵢ ∈ {xt, Cicᵢ^{t}≠0} (Formula 4)

where Xₜ is interaction vector, Cₜ is contextual information vector, C is learned transformation matrix, and “⊙” denotes element-wise multiplication. Concatenation may stack an interaction vector with a context information vector. Hence, this integration may not alter the interaction vector itself. On the other hand, multiplication may modify an interaction vector by the contextual information. Further, Bi-interaction encodes the second-order interactions between interaction vector and context information vector, and between context information vectors. Other integration methods may be used including, for example, pooling or any other integration method that might be apparent to a person of ordinary skill in the art.

At the recurrent layer, 611, a recurrent neural network 525 receives the integrated vector 626 and sequentially incorporates the integrated vector 626 into model of the user's total knowledge at time t. Depending on the user's history of usage of an educational system, the recurrent layer may include sequentially incorporate successive question/score pairs into a preexisting vector representation of the user's knowledge if the User has previously answered question, or a newly created vector representation if the user has never previously answered a question.

After the recurrent layer 611, a second integration layer 639 is provided to integrate the embedding vector 632 embedding the context information cₜ₊₁ 629 associated with a next question to be answered with the vector representation output of the RNN from the recurrent layer 611 to produce integration vector 635. Several, context integration methods may be used in example implementations, including:

concatenation:

[xₜ; cₜ] (Formula 1)

multiplication:

xₜ⊙Ccₜ (Formula 2)

concatenation and multiplication:

[xₜ⊙Ccₜ; Cr] (Formula 3)

bi-interaction::

ΣᵢΣⱼzⱼ⊙zⱼ, zᵢ ∈ {xt, Cicᵢ^{t}cᵢ^{t}≠0} (Formula 4)

where Xₜ is interaction vector, Cₜ is contextual information vector, C is learned transformation matrix, and “⊙” denotes element-wise multiplication. Concatenation may stack an interaction vector with a context information vector. Hence, this integration may not alter the interaction vector itself. On the other hand, multiplication may modify an interaction vector by the contextual information. Further, Bi-interaction encodes the second-order interactions between interaction vector and context information vector, and between context information vectors. Other integration methods may be used including, for example, pooling or any other integration method that might be apparent to a person of ordinary skill in the art. In some example implementations, the same integration technique may be used at both integration layers 637, 639. However, in other example implementations, different integration techniques may be used at each integration layer 637, 639.

At the mapping layer 614, the integration vector 635 may be mapped to a question newly being presented or being considered for presentation to the user to generate the vector 628, representing the user's knowledge and existing context of questions being presented. During the output layer 617, a probability 631 that the user will answer the subsequent question is output based the vector 628.

Evaluation

Based on the above, inventors performed valuation experiments using the Assistments 2012-2013 dataset. On the dataset, skill id as defined the identifier of a question. We removed the users with only one interaction. After preprocessing, the dataset includes 5,818,868 interactions of 45,675 users and 266 questions.

In the experiment, the following contextual features were used:

Sequence time gap: time gap between an interaction and the previous interaction;

Repeated time gap: time gap between interactions on the same question;

New question: a binary value where one indicates the question is assigned to a user for the first time and zero indicates the question has been assigned to the user before.

Two types of time gap are discretized at log 2 scale and with maximum value of 20. A 5-fold cross validation was conducted, in which the dataset is split based on a student. For evaluation measures, area under the curve (AUC) was used, which ranged from O (worst) to 1 (best).

TABLE 1
Prediction performance on the Assistments dataset 2012-2013

| Model | Area under curve (AUC) |
|---|---|
| DKT (baseline) | 0.7051 |
| Proposed (concat) | 0.7133 |
| Proposed (multi) | 0.7125 |
| Proposed (concat + multi) | 0.7157 |
| Proposed (bi-interaction) | 0.7189 |

Table 1 shows the prediction performance. The proposed models performed better than the baseline. Among integration methods, the combination of concatenation and multiplication improves the performance compared with each single integration method. Furthermore, bi-interaction obtains the best performance. Bi-interaction encodes the second-order interactions between interaction vector and context information vector, and between context information vectors. Owing to this, example implementation models may capture which pair of interaction and contextual information affects the students' knowledge more precisely.

Example Computing Environment

FIG. 7 illustrates an example computing environment 700 with an example computer device 705 suitable for use in some example implementations. Computing device 705 in computing environment 700 can include one or more processing units, cores, or processors 710, memory 715 (e.g., RAM, ROM, and/or the like), internal storage 720 (e.g., magnetic, optical, solid state storage, and/or organic), and/or I/O interface 725, any of which can be coupled on a communication mechanism or bus 730 for communicating information or embedded in the computing device 705.

Computing device 705 can be communicatively coupled to input/interface 735 and output device/interface 740. Either one or both of input/interface 735 and output device/interface 740 can be a wired or wireless interface and can be detachable. Input/interface 735 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 740 may include a display, television, monitor, printer, speaker, braille, or the like. In some example implementations, input/interface 735 (e.g., user interface) and output device/interface 740 can be embedded with, or physically coupled to, the computing device 705. In other example implementations, other computing devices may function as, or provide the functions of, an input/interface 735 and output device/interface 740 for a computing device 705. These elements may include, but are not limited to, well-known AR hardware inputs so as to permit a user to interact with an AR environment.

Examples of computing device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 705 can be communicatively coupled (e.g., via I/O interface 725) to external storage 745 and network 750 for communicating with any number of networked components, devices, and systems, including one or more computing devices of the same or different configuration. Computing device 705 or any connected computing device can be functioning as, providing services of, or referred to as a server, client, thin server, general machine, special-purpose machine, or another label.

I/O interface 725 can include, but is not limited to, wired and/or wireless interfaces using any communication or I/O protocols or standards (e.g., Ethernet, 702.11xs, Universal System Bus, WiMAX, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computing device 705 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS) (not shown), in a native or virtual environment. One or more applications can be deployed that include logic unit 755, application programming interface (API) unit 760, input unit 765, output unit 770, context detection unit 775, integration unit 780, probability calculation unit 785, and inter-unit communication mechanism 795 for the different units to communicate with each other, with the OS, and with other applications (not shown).

For example, the context detection unit 775, integration unit 780, probability calculation unit 785 may implement one or more processes shown in FIGS. 1, 4, and 6. The described units and elements can be varied in design, function, configuration, or implementation and are not limited to the descriptions provided.

In some example implementations, when information or an execution instruction is received by API unit 760, it may be communicated to one or more other units (e.g., context detection unit 775, integration unit 780, and probability calculation unit 785). For example, the context detection unit 775 may detect context information associated with one or more question answer pairs by extracting metadata, or using one or more recognition techniques such as object recognition, text recognition, audio recognition, image recognition or any other recognition technique that might be apparent to a person of ordinary skill in the art. Further, integration unit 780 may integrate detected context information to produce vector representations of the detected context information. Further, the probability calculation unit 785 may calculate probability of a user answering one or more potential questions based on the vector representations and selecting questions based on the calculated probability.

In some instances, the logic unit 755 may be configured to control the information flow among the units and direct the services provided by API unit 760, input unit 765, context detection unit 775, integration unit 780, probability calculation unit 785 in some example implementations described above. For example, the flow of one or more processes or implementations may be controlled by logic unit 755 alone or in conjunction with API unit 760.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A method of tailoring training questions to a specific user in a computer based training system, the method comprising:
detecting, by a neural network at least one relationship pair, each relationship pair comprising a question previously answered by the specific user and the specific user's previous score for at least one previously answered question;
detecting, by the neural network, context information associated with the at least one question previously answered by the user, the context information representing conditions or circumstances occurring at the time of the user previously answered the at least one question;
determining, by the neural network, a probability that the specific user will successfully answer a subsequent question selected from a plurality of potential questions based on the detected relationship pairs, the detected context information associated with the at least one question previously answered by the user, and context information associated with at least one potential question to be answered by the user; and
selecting questions to be answered by the user based on the determined probability in order to facilitate training of the user.

2. The method of claim 1, wherein the determining the probability comprises:
detecting, by the neural network, context information associated with the at least one potential question to be presented to the specific user, the context information representing conditions or circumstances occurring at the time of the at least one question is to be presented to the specific user; and
calculating, by the neural network, a probability the specific user will successfully answer the at least one potential question successfully based on the detected relationship pairs, the detected context information associated with the at least one question previously answered by the user, and the detected context information associated with the at least one potential question to be presented to the specific user.

3. The method of claim 2, wherein the context information associated with the at least one potential question to be presented to the specific user includes one or more of a current time elapsed since the specific user was presented with a question, a time elapsed since the specific user previously encountered a same topic as the at least one potential question, whether the specific user has encountered the at least one potential question, and a time elapsed since the specific user previously encountered the at least one potential question.

4. The method of claim 2, wherein the calculating a probability the specific user will successfully answer the at least one potential question comprises:
embedding the detected at least one relationship pair in a question pair vector representation;
embedding the detected context information associated with the at least one question previously answered by the user in an answered question vector representation;
embedding the detected context information associated with the at least one potential question in a potential question vector representation; and
integrating the question pair vector representation, the answered question vector representation, and the potential question vector representation to produce a probability vector representation.

5. The method of claim 4, wherein a bi-interaction integration method is used to integrate the question pair vector representation, the answered question vector representation, and the potential question vector representation.

6. The method of claim 1, wherein the context information associated with the at least one question previously answered by the user includes one or more of the time elapsed between the question being presented and an answer being received from the user, whether the user has encountered the question before, how the user has previously answered the question when previously presented, whether the question relates to a topic previously encountered by the user.

7. The method of claim 1, wherein the determining a probability that the specific user will successfully answer a subsequent question comprises:
embedding the detected at least one relationship pair in a question pair vector representation;
embedding the detected context information associated with the at least one question previously answered by the user in an answered question vector representation; and
integrating the question pair vector representation, and the answered question vector representation to produce a probability vector representation.

8. The method of claim 6, wherein the integrating comprises using a context integration method including one or more or:
concatenation;
multiplication;
concatenation and multiplication;
pooling; and
bi-interaction.

9. A method of tailoring training questions to a specific user in a computer based training system, the method comprising:
detecting, by a neural network, at least one relationship pair, each relationship pair comprising a question previously answered by the specific user and the specific user's previous score for at least one previously answered question;
detecting, by the neural network, context information associated with at least one potential question to be presented to the specific user, the context information representing conditions or circumstances occurring at the time of the at least one question is to be presented to the specific user;
determining, by the neural network, a probability that the specific user will successfully answer the at least one potential question based on the detected at least one relationship pair and the detected context information associated with at least one potential question to be presented to the specific user; and
selecting questions to be answered by the user based on the determined probability in order to facilitate training of the user.

10. The method of claim 9, wherein the determining the probability comprises:
detecting, by the neural network, context information associated with the at least one question previously answered by the user, the context information representing conditions or circumstances occurring at the time of the user previously answered the at least one question; and
calculating, by the neural network, a probability the specific user will successfully answer the at least one potential question successfully based on the detected relationship pairs, the detected context information associated with the at least one question previously answered by the user, and the detected context information associated with the at least one potential question to be presented to the specific user.

11. The method of claim 10, wherein the context information associated with the at least one question previously answered by the user includes one or more of the time elapsed between the question being presented and an answer being received from the user, whether the user has encountered the question before, how the user has previously answered the question when previously presented, whether the question relates to a topic previously encountered by the user.

12. The method of claim 10, wherein the calculating a probability the specific user will successfully answer the at least one potential question comprises:
embedding the detected at least one relationship pair in a question pair vector representation;
embedding the detected context information associated with the at least one question previously answered by the user in an answered question vector representation;
embedding the detected context information associated with the at least one potential question in a potential question vector representation; and
integrating the question pair vector representation, the answered question vector representation, and the potential question vector representation to produce a probability vector representation.

13. The method of claim 12 wherein a bi-interaction integration method is used to integrate the question pair vector representation, the answered question vector representation, and the potential question vector representation.

14. The method of claim 9, wherein the context information associated with the at least one potential question to be presented to the specific user includes one or more of a current time elapsed since the specific user was presented with a question, a time elapsed since the specific user previously encountered a same topic as the at least one potential question, whether the specific user has encountered the at least one potential question, and a time elapsed since the specific user previously encountered the at least one potential question.

15. The method of claim 9, wherein the determining a probability that the specific user will successfully answer a subsequent question comprises:
embedding the detected at least one relationship pair in a question pair vector representation;
embedding the detected context information associated with the at least one potential question in a potential question vector representation; and
integrating the question pair vector representation, and the potential question vector representation to produce a probability vector representation.

16. The method of claim 15, wherein the integrating comprises using a context integration method including one or more or:
concatenation;
multiplication;
concatenation and multiplication;
pooling; and
bi-interaction.

17. A non-transitory computer readable medium having stored therein a program for making a computer execute a method of tailoring training questions to a specific user in a computer based training system, the method comprising:
detecting, by a neural network at least one relationship pair, each relationship pair comprising a question previously answered by the specific user and the specific user's previous score for at least one previously answered question;
detecting, by the neural network, context information associated with the at least one question previously answered by the user, the context information representing conditions or circumstances occurring at the time of the user previously answered the at least one question;
detecting, by the neural network, context information associated with the at least one potential question to be presented to the specific user, the context information representing conditions or circumstances occurring at the time of the at least one question is to be presented to the specific user;
determining, by the neural network, a probability that the specific user will successfully answer the at least one potential question successfully based on the detected relationship pairs, the detected context information associated with the at least one question previously answered by the user, and the detected context information associated with the at least one potential question to be presented to the specific user; and
selecting questions to be answered by the user based on the determined probability in order to facilitate training of the user.

18. The non-transitory computer readable medium of claim 17, wherein the context information associated with the at least one question previously answered by the user includes one or more of the time elapsed between the question being presented and an answer being received from the user, whether the user has encountered the question before, how the user has previously answered the question when previously presented, whether the question relates to a topic previously encountered by the user; and
wherein the context information associated with the at least one potential question to be presented to the specific user includes one or more of a current time elapsed since the specific user was presented with a question, a time elapsed since the specific user previously encountered a same topic as the at least one potential question, whether the specific user has encountered the at least one potential question, and a time elapsed since the specific user previously encountered the at least one potential question.

19. The non-transitory computer readable medium of claim 17, wherein the determining a probability that the specific user will successfully answer the at least one potential question comprises:
embedding the detected at least one relationship pair in a question pair vector representation;
embedding the detected context information associated with the at least one question previously answered by the user in an answered question vector representation;
embedding the detected context information associated with the at least one potential question in a potential question vector representation; and
integrating the question pair vector representation, the answered question vector representation, and the potential question vector representation to produce a probability vector representation.

20. The non-transitory computer readable medium of claim 17, wherein a bi-interaction integration method is used to integrate the question pair vector representation, the answered question vector representation, and the potential question vector representation.
